(19) United States
(12) Patent Application Publication
(10) Pub. No.: US 2023/0188939 A1
(43) Pub. Date: Jun. 15, 2023

(54) INFORMATION PROCESSING APPARATUS, INFORMATION PROCESSING SYSTEM, AND INFORMATION PROCESSING METHOD

(71) Applicant: DENSO TEN Limited, Kobe-shi (JP)

(72) Inventors: Rei HIROMI, Kobe (JP); Shinichi TANAKA, Kobe (JP); Hideyuki KAMIDE, Kobe (JP); Toshiyuki MORIBAYASHI, Kobe (JP); Masaki URYU, Kobe (JP); Shinichi SHIOTSU, Kobe (JP); Minoru MAEHATA, Kobe (JP)

(73) Assignee: DENSO TEN Limited, Kobe-shi (JP)

(21) Appl. No.: 17/689,099

(22) Filed: Mar. 8, 2022

(30) Foreign Application Priority Data
Dec. 10, 2021 (JP) 2021-200742

(51) Int. Cl. H04W 4/029; H04W 4/02; H04L 67/50

(52) U.S. Cl. CPC H04W 4/029; H04W 4/023; H04L 67/22

(57) ABSTRACT

An information processing apparatus according to embodiments includes a control circuitry configured to determine an environmental contribution level of a behavior performed by a user. The control circuitry is further configured to: acquire behavior information related to a behavior of a user analyze the behavior of the user based on the acquired behavior information; and determine an environmental contribution level of the behavior of the user based on relative evaluation of the analyzed behavior of the user with respect to a reference behavior.

### CROSS-REFERENCE TO RELATED APPLICATION

This application is based upon and claims the benefit of priority of the prior Japanese Patent Application No. 2021-200742, filed on Dec. 10, 2021, the entire contents of which are incorporated herein by reference.

### FIELD

The embodiment discussed herein is directed to an information processing apparatus, an information processing system, and an information processing method.

### BACKGROUND

Conventionally, there has been known a system that evaluates, by using point-conversion according to CO2 reduction amount, a behavior such as walking up stairs without using an elevator in a building, as an environmental contribution activity (hereinafter, may be referred to as “environmental contribution activity”) that contributes to reduction in CO2 (see Japanese Laid-open Patent Publication No. 2011-123599, for example).

However, the conventional technology has room for improvement in evaluating an environmental contribution activity of a user in accordance with an actual condition.

For example, movement by walking is commonly recognized as an environmental contribution activity that contributes to reduction in CO2; however, movement by walking over a short distance is a common behavior that does not need movement by vehicle, and thus it can't be completely defined as the environmental contribution activity.

### SUMMARY

An information processing apparatus according to one aspect of embodiments includes a control circuitry configured to determine an environmental contribution level of a behavior performed by a user. The control circuitry is further configured to: acquire behavior information related to a behavior of a user; analyze the behavior of the user based on the acquired behavior information; and determine an environmental contribution level of the behavior of the user based on relative evaluation of the analyzed behavior of the user with respect to a reference behavior.

### BRIEF DESCRIPTION OF DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a diagram illustrating the outline of an information processing method according to an embodiment;

FIG. 2 is a diagram illustrating reference behavior information according to the embodiment;

FIG. 3 is a diagram illustrating an environmental contribution user level according to the embodiment;

FIG. 4 is a diagram illustrating a configuration example of an information processing system according to the embodiment;

FIG. 5 is a block diagram illustrating a configuration example of a server device according to the embodiment;

FIGS. 6 to 10 are diagrams illustrating change examples of the reference behavior information;

FIGS. 11 and 12 are diagrams illustrating application screen examples according to the embodiment;

FIG. 13 is a diagram illustrating an application screen example when an option is specified;

FIG. 14 is a diagram illustrating relation between an option parameter and a reference behavior condition;

FIG. 15 is a diagram illustrating an application screen example according to a modification, which is in accordance with a user level; and

FIG. 16 is a flowchart illustrating a processing procedure to be executed by the server device according to the embodiment.

### DESCRIPTION OF EMBODIMENTS

Hereinafter, embodiments of an information processing apparatus, an information processing system, and an information processing method will be described in detail with reference to the accompanying drawings. Moreover, the disclosed technology is not limited to the embodiments described below.

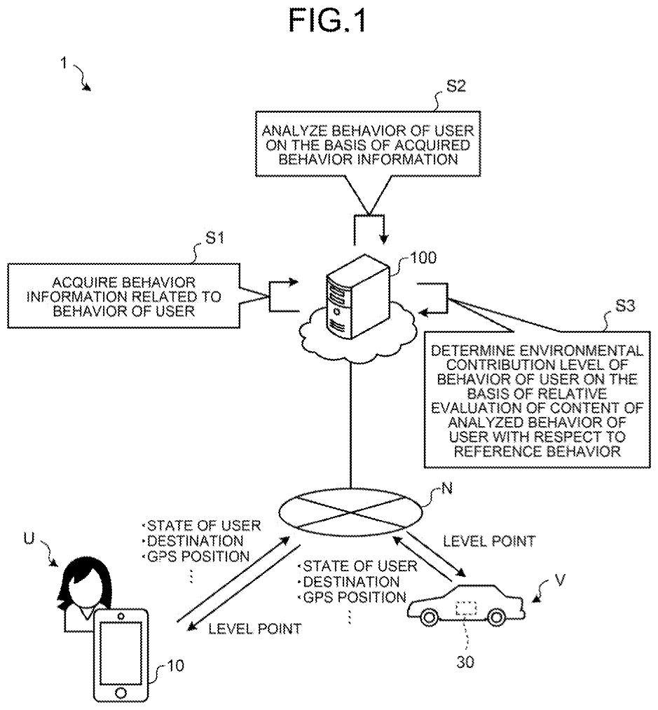

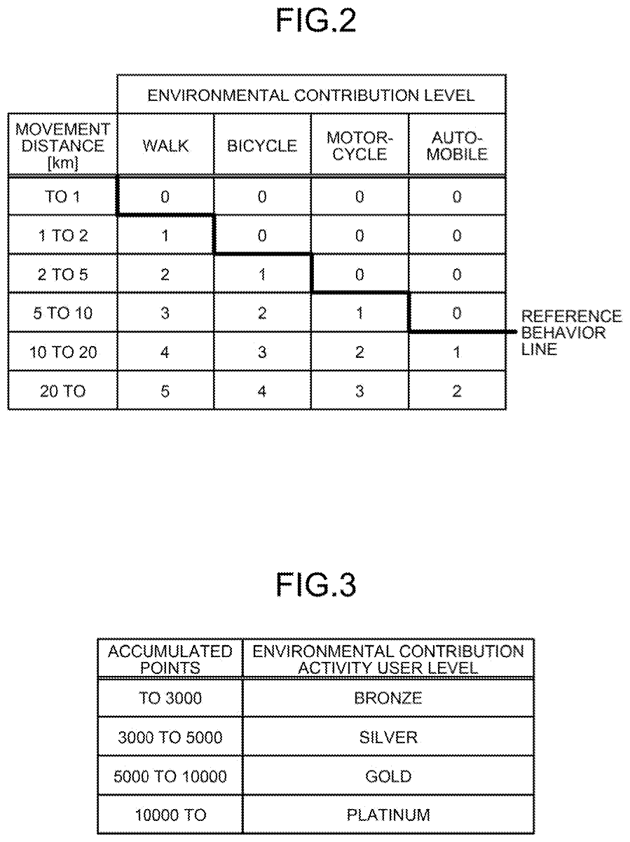

The outline of an information processing method according to an embodiment will be explained with reference to FIGS. 1 to 3. FIG. 1 is a diagram illustrating the outline of the information processing method according to the embodiment. FIG. 2 is a diagram illustrating reference behavior information 102b according to the embodiment. FIG. 3 is a diagram illustrating an environmental contribution user level according to the embodiment.

Incidentally, the conventional technology has room for improvement in evaluating an environmental contribution activity of a user in accordance with an actual condition.

For example, movement by walking is commonly recognized as an environmental contribution activity that contributes to reduction in CO2; however, movement by walking over a short distance is a common behavior that does not need movement by vehicle, and thus it can't be completely defined as the environmental contribution activity.

Thus, an information processing method according to the embodiment is configured to include: acquiring behavior information related to a behavior of a user; analyzing the behavior of the user on the basis of the acquired behavior information; and determining an environmental contribution level of the behavior of the user on the basis of relative evaluation of a content of the analyzed behavior of the user with respect to a reference behavior.

Specifically, as illustrated in FIG. 1, in the information processing method according to the embodiment, a server device 100 acquires behavior information related to a behavior of a user U from a user terminal 10 that is used by the user U or an on-vehicle device 30 of a vehicle V on which the user U is getting via a network N such as the Internet and a mobile telephone network (Step S1).

The behavior information related to a behavior of the user U includes a user state that is a state of the user U, a destination, a Global Positioning System (GPS) position, and the like. The server device 100 acquires the behavior information related to a behavior of the user U via an application for evaluating an environmental contribution activity, which operates in the user terminal 10 and/or the on-vehicle device 30, for example.

The server device 100 analyzes a behavior of the user U on the basis of the acquired behavior information (Step S2). The server device 100 analyzes an actual condition of a behavior of the user U such as a movement method actually employed by the user U to a destination, on the basis of a movement route and/or a moving speed of a GPS position and the like, for example.

The server device 100 determines an environmental contribution level of a behavior of the user U on the basis of relative evaluation of a content of the analyzed behavior of the user U with respect to a reference behavior (Step S3). Herein, the reference behavior is set in the server device 100 as the reference behavior information 102b.

One example of the reference behavior information 102b illustrated in FIG. 2 includes information with which a level value of an environmental contribution level is associated for each movement, method in accordance with a movement distance. Herein, a combination of a movement distance and a movement method corresponds to a “behavior content” that is constituted of a “movement method” and a “behavior amount” of a behavior having been actually taken by the user U. In other words, the information is for deciding an environmental contribution level on the basis of a behavior content (“movement method” (generally “behavior type”) and “behavior amount”) having been actually taken by the user U, and is stored as table data to be used in a process for determining an environmental contribution level and the like.

A reference behavior line that is a virtual reference of an environmental contribution activity is set for the reference behavior information 102b. In other words, the reference behavior line is a boundary between a common movement behavior that will be commonly selected by a person with respect to a movement distance regardless of an environmental contribution activity and a movement behavior as an environmental contribution activity. The reference behavior line corresponds to one example of a “reference behavior”. In an information processing method according to the embodiment, whether or not being an environmental contribution activity is determined on the basis of comparison between the above-mentioned “reference behavior” (reference behavior line) and the above-mentioned “behavior content” of the user U.

In the example illustrated in FIG. 2, a case is exemplified where a part upper than the illustrated reference behavior line (side of lower movement distance) is estimated as a common movement behavior. Therefore, in the information processing method according to the embodiment, with respect to a movement distance, in a case where the user U moves with a behavior content (movement method and movement distance) that corresponds to the part upper than the illustrated reference behavior line, a movement behavior of the user U is not determined to be an environmental contribution activity.

Note that the reference behavior line is virtual, and thus an environmental contribution level of a “behavior content” portion (side upper than reference behavior line illustrated in FIG. 2) in an environmental contribution level that is lower than a reference behavior line is set to “0” (or may be another predetermined value to be identified) to be able to execute processing based on the reference behavior line. In the example illustrated in FIG. 2, the higher an environmental contribution level of a behavior is, the lower the behavior positions in the table. Moreover, a reference behavior line may separately stored as data, and in this case, a value (threshold) of the reference behavior line is stored for each of items (in FIG 2, “walk”, “bicycle”, “motorcycle”, and “automobile”) of the environmental contribution level.

On the other hand, in the information processing method according to the embodiment, in a case where the user U moves with a “behavior content” whose environmental contribution level is higher than a reference behavior line a movement behavior of the user U is determined to be an environmental contribution activity. Thus, in the example illustrated in FIG. 2, an environmental contribution level in the above-mentioned case is set to values of any of “1” to “5”, as data that indicates to be an environmental contribution activity and a level thereof, in accordance with the “behavior content” (movement distance and movement method).

In FIG. 2, as an item for deciding a behavior amount, a “movement distance” is exemplified; however, not limited thereto, the item may be a “movement time interval” or the like instead of a movement distance. Furthermore, may be applied to a behavior associated with environmental contribution other than movement, such as a temperature setting state of an air conditioner; in a case of a temperature setting state of an air conditioner, for example, application of “temperature setting” may be considered as a “behavior content” (items in vertical axes illustrated in FIG. 2), additionally, application of an item correlated to temperature setting, such as a temperature adjustment position (correlated to exercise quantity of person in room), may be considered (items in lateral axes illustrated in FIG. 2). Note that in the present embodiment, a “movement behavior” that is typical and comprehensible is exemplified to proceed explanation.

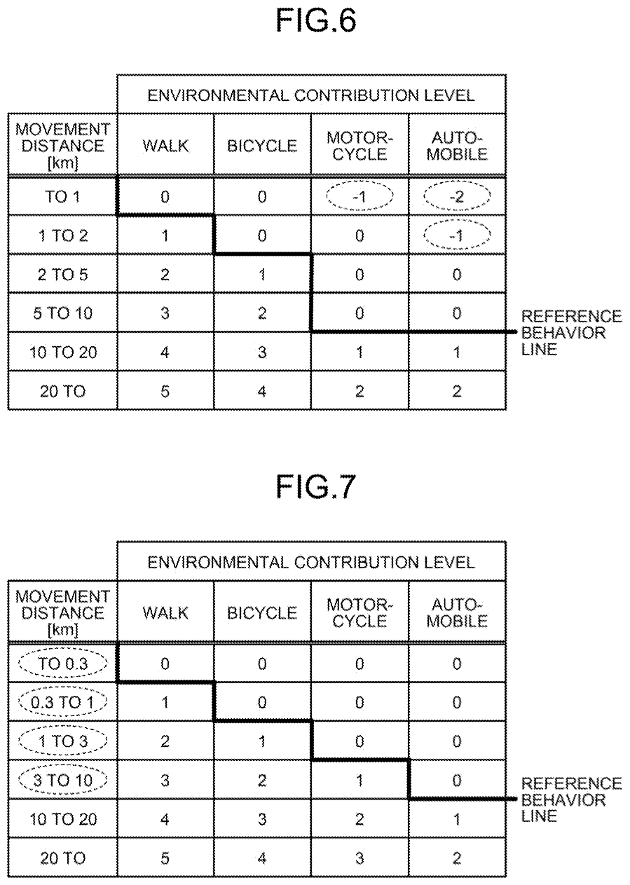

The reference behavior information 102b may be dynamically changed in accordance with a state of the user U including presence/absence of luggage, presence/absence of his/her accompanier, and the like, which are included in information related to a behavior of the user U; a peripheral situation of the user U including the weather; a user level according to a past environmental contribution level of the user U; and the like. Details of this point will be explained later with reference to FIGS. 6 to 10, FIGS. 13 to 15, and the like.

It is desirable that a “reference behavior” (reference behavior line) illustrated in FIG. 2, which is the reference behavior information 102b, is moved (changed) in accordance with various situations as described above, the method for changing may include a method for changing a value of an environmental contribution level in each of “behavior content” frames illustrated in FIG. 2 (in present embodiment, boundary between “0” and natural number is reference behavior line), and a method for changing a “behavior content” (movement distance) threshold.

The server device 100 compares an analyzed actual condition of a behavior of the user U with the reference behavior information 102b, and further extracts a corresponding environmental contribution level so as to determine an environmental contribution level with respect to a behavior content of the user U.

The server device 100 converts the determined environmental contribution level into a level point to be provided to the user U under a condition of predetermined conversion condition and/or formula, for example, “ten times of environmental contribution level is defined as level point”.

Returning to explanation of FIG. 1. The server device 100 provides a calculated level point to the user U. An environmental contribution user level is set for the user U in accordance with the provided and accumulated points.

As illustrated in FIG. 3, an environmental contribution user level is set so as to increase a level thereof as an accumulated point is larger, and is managed by the server device 100. The server device 100 provides a point service in accordance with accumulated points and an environmental contribution user level, for example, to provide a benefit to the user U. According to the above-mentioned provision of a point service, it is possible to cause the user U to muster his/her motivation for an environmental contribution activity, for example. Note that the server device 100 may provide information on accumulated points and/or an environmental contribution user level of a user to a server device of another point service system so as to provide a benefit to a target user from the above-mentioned other point service system.

As described above, the information processing method according to the embodiment is configured to include: acquiring behavior information related to a behavior of the user U; analyzing the behavior of the user U on the basis of the acquired behavior information; and determining an environmental contribution level of the behavior of the user U on the basis of relative evaluation of the analyzed behavior content of the user U with respect to a reference behavior.

Therefore, in accordance with the information processing method according to the embodiment, it is possible to evaluate an environmental contribution activity of the user U in accordance with an actual condition. Hereinafter, a configuration example of an information processing system 1 for which the information processing method according to the embodiment is employed will be explained more specifically.

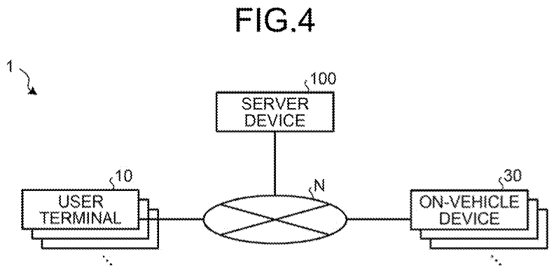

FIG. 4 is a diagram illustrating a configuration example of the information processing system 1 according to the embodiment. As illustrated in FIG. 4, the information processing system 1 includes the at least one user terminal 10, the at least one on-vehicle device 30, and the server device 100.

As illustrated in FIG. 4, the user terminal 10, the on-vehicle device 30, and the server device 100 are connected to each other by the above-mentioned network N, and are configured to transmit and receive data to and from each other via the network N.

The user terminal 10 is a terminal device that is carried and used by the user U, and includes a platform in which an application according to the information processing system 1 operates. The user terminal 10 is, for example, a mobile telephone such as a smartphone, a tablet terminal, or the like. Additionally, the user terminal 10 may be a Personal Computer (PC), a Personal Digital Assistant (PDA), a wearable device having a wristwatch-type, an eyeglass-type, or the like, etc.

The on-vehicle device 30 is a computer mounted on the vehicle V, and includes a platform in which an application according to the information processing system 1 operates. Note that the vehicle V according to the information processing system 1 is not limited to an automobile, and may be a bicycle, a motorcycle, or the like. Each of the user terminal 10 and the on-vehicle device 30 is one example of a “terminal device”.

The server device 100 is one example of an “information processing apparatus” and is realized as a cloud server, for example, and provides function of the above-mentioned application to the user terminal 10 and the on-vehicle device 30 via the network N. The server device 100 executes processes of the above-mentioned Step S1 to Step S3 via the above-mentioned function of the application.

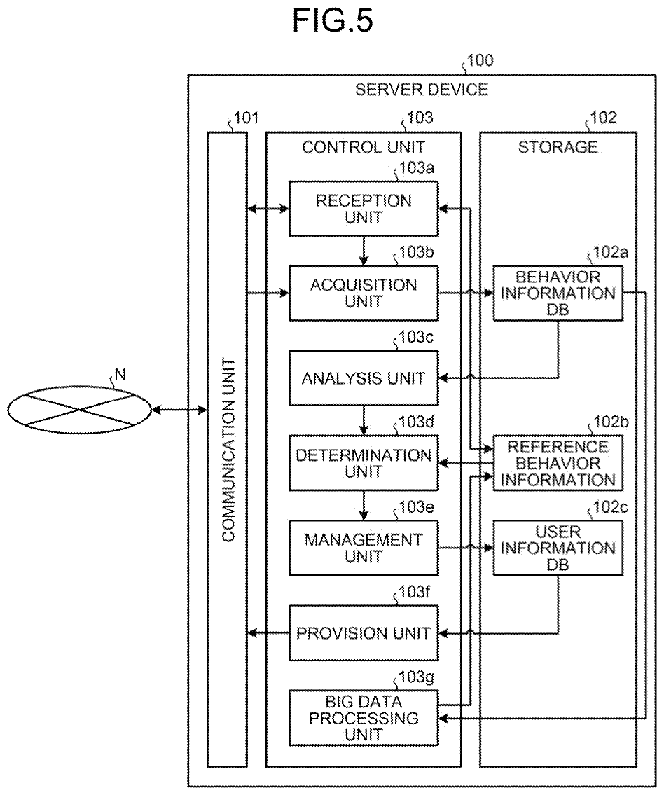

Next, FIG. 5 is a block diagram illustrating a configuration example of the server device 100 according to the embodiment. In FIG. 5, configuration elements needed for explaining features of the embodiment alone are indicated, and description of common configuration elements is omitted.

In other words, specific forms of distribution and integration of the configuration elements illustrated in FIG. 5 are not limited to those illustrated in the drawings. All or some of the devices can be configured by separating or integrating the apparatus functionally or physically in any unit, according to various types of loads, the status of use, etc.

In the explanation with reference to FIG. 5, explanation of already-explained configuration elements is simplified or omitted in some cases.

As illustrated in FIG. 5, the server device 100 according to the embodiment includes a communication unit 101, a storage 102, and a control unit 103. The control unit 103 is one example of a “control circuitry”.

The communication unit 101 is realized by, for example, a Network Interface Card (NIC), and the like. The communication unit 101 is connected to the above-mentioned network N in a wired or wireless manner, and transmits and receives information to and from the user terminal 10 and the on-vehicle device 30 via the network N.

The storage 102 is realized by a semiconductor memory element such as a Random Access Memory (RAM) and a Flash Memory, or a storage such as a hard disk and an optical disk. In the example illustrated in FIG. 5, the storage 102 stores therein a behavior information Data Base (DB) 102a, the reference behavior information 102b, and a user information DB 102c.

The behavior information DB 102a is a database in which information related to a behavior of the user U which is acquired by an acquisition unit 103b to be mentioned later is accumulated.

The reference behavior information 102b has been already explained, and as described above, the reference behavior information 102b is capable of dynamically changing setting. The reference behavior information 102b is changed by a reception unit 103a and/or a big data processing unit 103g that are to be mentioned later.

FIGS. 6 to 10 are diagrams illustrating change examples of the reference behavior information 102b.

In FIG. 2, the example of the reference behavior information 102b is indicated in which a reference behavior line is in a staircase pattern by a single step; however, not limited to a single step, and equal to or more than two steps may be employed, or there may be no level difference. As the above-mentioned example, in FIG. 6, there is indicated a case where a gap between a bicycle and a motorcycle is two steps, and there presents no level difference between a motorcycle and an automobile. As illustrated in FIG. 6, in a case where a behavior is estimated to be a common movement behavior with respect to a movement distance, which is above a reference behavior line, for example, the reference behavior information 102b may set a level value of an environmental contribution level to a minus value (see portions surrounded by closed curves in FIG. 6).

For example, it means that in a case where the user U uses a movement method that is not to be used as an environmental contribution activity for a short distance, a minus point is provided to the user U. In this meaning, it is able to be said that the example illustrated in FIG. 6 “tightens” reference behavior condition related to an environmental contribution activity.

As illustrated in FIG. 7, the reference behavior information 102b is capable of changing a division unit (determination threshold distance) of a movement distance, for example, (see portions surrounded by closed curves in FIG. 7). In FIG. 7, an example is indicated in which a division unit is further reduced for a movement distance of equal to or less than 10 km than the cases illustrated in FIGS. 2 and 6. It is able to be said that the above-mentioned example “eases” the above-mentioned reference behavior condition. Additionally, the division unit may be increased in accordance with an environmental contribution user level of the user U in order to “tighten” the above-mentioned reference behavior condition, for example.

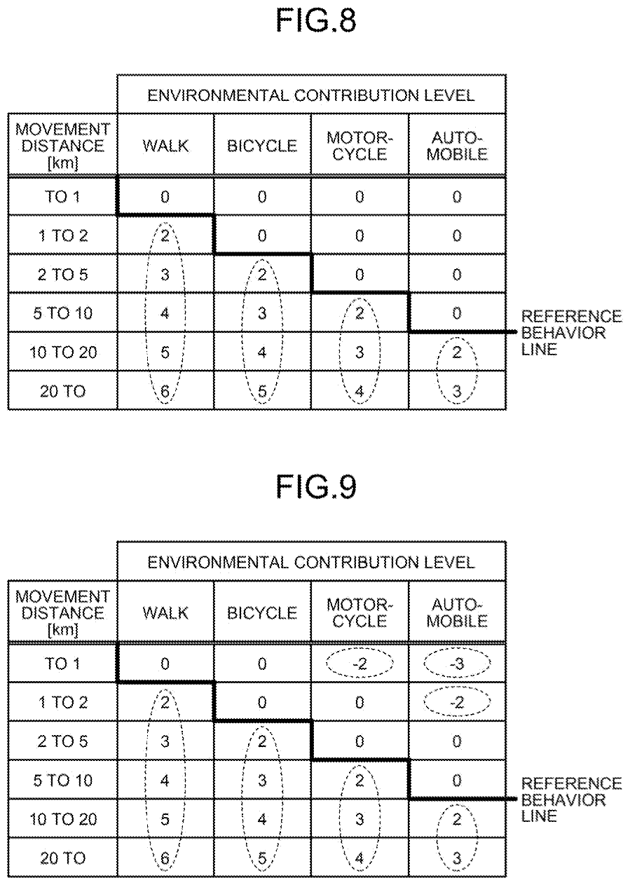

As illustrated in FIG. 8, the reference behavior information 102b is capable of changing a level value of an environmental contribution level of each of the movement methods that are determined to be environmental contribution activities under a reference behavior line, for example (see portions surrounded by closed curves in FIG. 8). In FIG. 8, an example is indicated in which a level value is further increased than the cases illustrated in FIGS. 2, 6, and 7. It is able to be said that the above-mentioned example “eases” the above-mentioned reference behavior condition. Additionally, a level value may be reduced in order to “tighten” the above-mentioned reference behavior condition.

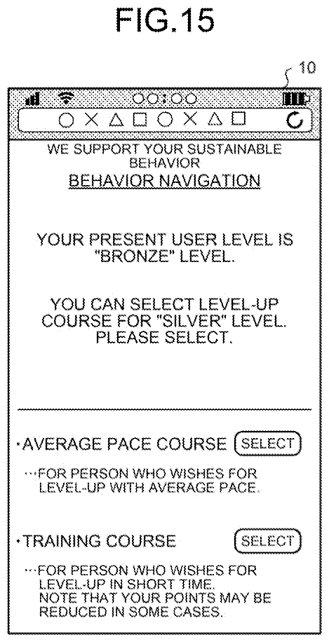

As illustrated in FIG. 9, similarly to the example illustrated in FIG. 8, the reference behavior information 102b increases a level value of an environmental contribution level of each of the movement methods under a reference behavior line, for example. Similarly to the example illustrated in FIG. 6, a level value of each of the movement methods above a reference behavior line may be set to a minus value. It is able to be said that the example illustrated in FIG. 9 increases an increase/decrease amount of a level point, and thus it is possible to provide, to the user U, game characteristics whose merit is large but whose demerit is also large, for example. Details thereof will be mentioned later with reference to FIG. 15.

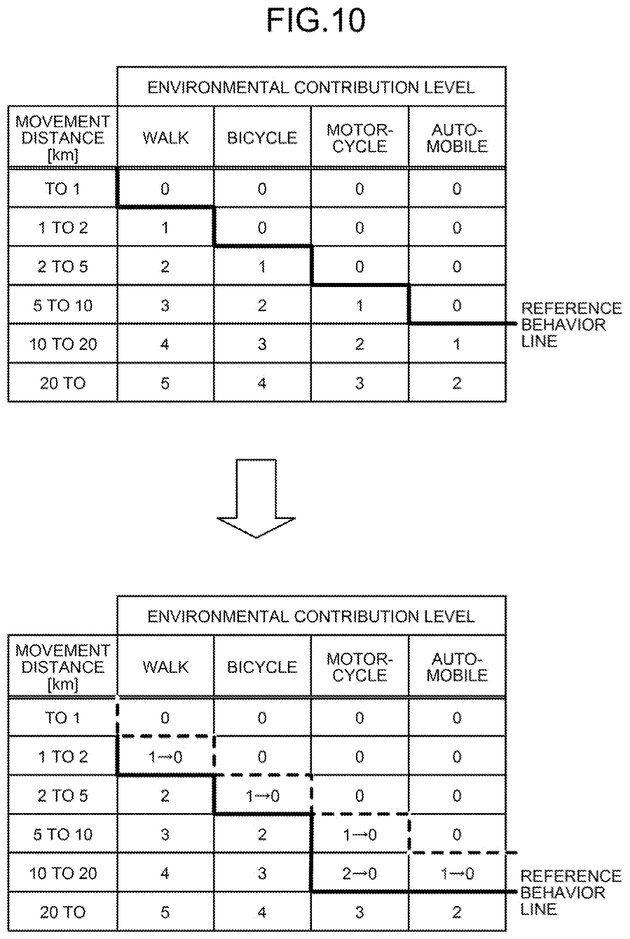

Similarly, a reference behavior line may be dynamically changed in accordance with a state and/or a peripheral situation of the user U, an environmental contribution user level of the user U, and the like by, for example, raising or lowering a reference behavior line. For example, in FIG. 10, a case is exemplified in which whole of a reference behavior line is lowered by one step and further a gap between a bicycle and a motorcycle is set to two steps.

Returning to explanation of FIG. 5. The user information DB 102c that is stored in the storage 102 is a database for managing the above-mentioned accumulated points and the above-mentioned environmental contribution user level of each of the users U.

The control unit 103 is a controller, and is realized when a Central Processing Unit (CPU), a Micro Processing Unit (MPU), or the like executes not-illustrated various programs stored in the storage 102 by using a RAM as a work region, for example. The control unit 103 may be realized by an integrated circuit such as an Application Specific Integrated Circuit (ASIC) and a Field Programmable Gate Array (FPGA).

The control unit 103 includes a reception unit 103a, the acquisition unit 103b, an analysis unit 103c, a determination unit 103d, a management unit 103e, a provision unit 103f, and a big data processing unit 103g, and further realizes or executes functions and working of information processing to be mentioned later.

The reception unit 103a receives an application use request of the user U from the user terminal 10 or the on-vehicle device 30 via the communication unit 101. The application use request includes information related to the user U, such as a state and an attribute of the user U, and the reception unit 103a appropriately changes the reference behavior information 102b on the basis thereof.

An application use request includes a destination that is specified by the user U, and the reception unit 103a presents, for example, guidance information to the user U on the basis of the above-mentioned destination and the reference behavior information 102b.

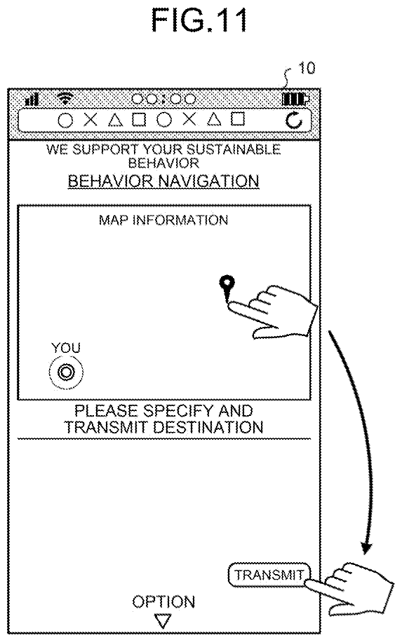

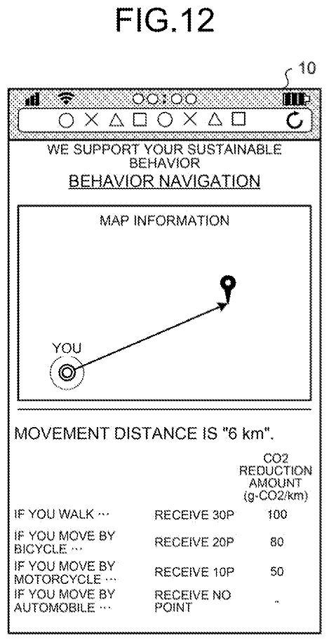

FIGS. 11 and 12 are diagrams illustrating application screen examples according to the embodiment.

As illustrated in FIG. 11, when the user U starts up the above-mentioned application in the user terminal 10, the application presents a present position along with map information, for example, on a screen of the user terminal 10, and further prompts the user U to specify and transmit a destination. As illustrated in FIG. 11, assume that the user U specifies a destination on map information, and taps a transmission button.

Subsequently, an application use request including information on the specified destination along with information on the user U that is preliminarily set in the application is transmitted to the server device 100. The reception unit 103a receives the request, adjusts the reference behavior information 102b in accordance with the information related to the user U, and further generates guidance information for the user U on the basis of the adjusted reference behavior information 102b and the destination information so as to present the information to the user U.

One example of the presented screen is illustrated in FIG. 12. In the presented screen, as illustrated in FIG. 12, for example, there are displayed, in addition to a movement distance up to a destination specified by the user U, level points to be acquired by movement methods, environmental contribution indexes (CO2 reduction amount and the like: reduction amount with reference to automobile movement, in FIG. 12), and the like.

Thus, the user U is able to grasp, via the screen, a point amount to be acquired and CO2 reduction amount (environmental contribution amount) for each of the movement methods, and further to obtain reference information when he/her selects a movement method.

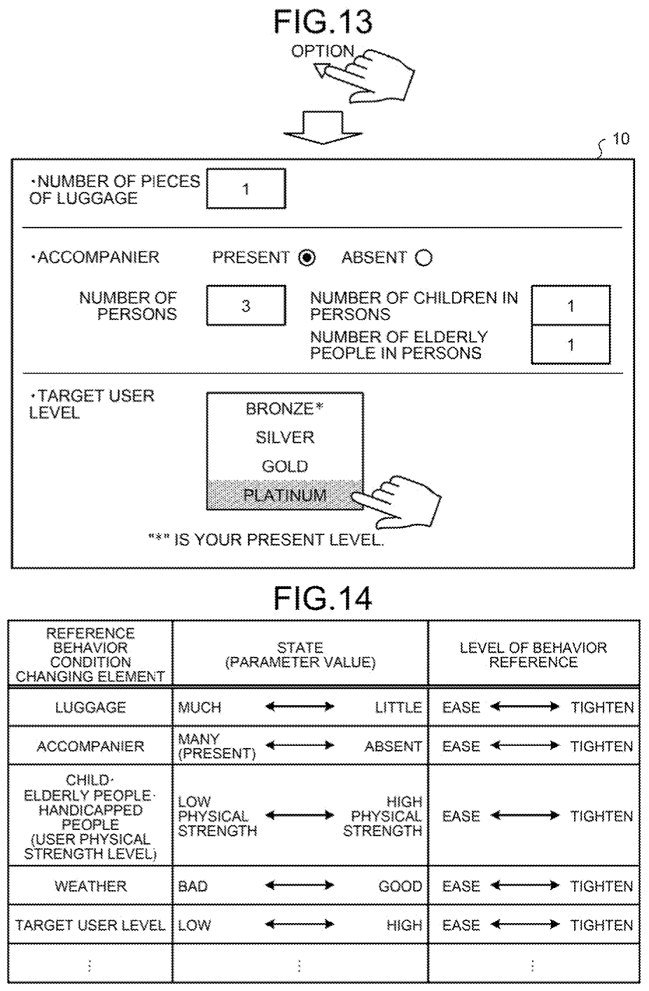

The reception unit 103a has been explained to change the reference behavior information 102b in accordance with information related to the user U, change elements include the following to be explained below, and an option parameter of a change element is set/changed (for example, changed by manual operation of user U, peripheral environment detected by various sensors, or the like) so as to change the reference behavior Information 102b. FIG. 13 is a diagram illustrating an application screen example when an option is specified.

FIG. 14 is a diagram illustrating relation between an option parameter and a reference behavior condition, and there is indicated relation between ease/tightening of option parameters and reference behavior conditions in change elements of reference behavior condition to be mentioned below. In FIG. 14, for convenience of explanation, although there presents a part in which a value is expressed by using a sentence, it is actually a data table in which numeric values for adjusting reference behavior information and the like are stored, and is used in various processes. FIG. 15 is a diagram illustrating an application screen example according to a modification, which is in accordance with a user level.

Change elements of reference behavior condition will be explained. Change elements of reference behavior condition include, for example, “presence/absence of luggage”, “presence/absence of accompanier”, “child⋅elderly people⋅handicapped people (user physical strength level)”, “weather”, “target user level”, and the like.

Regarding “presence/absence of luggage”, in a case where there presents luggage, use of an automobile whose environmental load is commonly high and the like is tolerated. Particularly, the tendency is stronger as luggage is heavier or larger. Therefore, it is preferable that a reference behavior is eased/tightened by presence/absence of luggage and extent thereof. In other words, it is preferable that in a case where there presents luggage and a weight/size thereof is large, a reference behavior is largely eased, for example, and in a case of a heavy luggage, a few points are provided even in a case of movement using an automobile, and points to be provided are increased in a case of movement using a motorcycle.

Regarding “presence/absence of accompanier”, in a case of a group behavior, there presents variation in a member constitution, and further a plurality of persons uses the same transportation method, and thus use of an automobile whose environmental load is commonly high and the like is tolerated. Therefore, it is preferable that a reference behavior is eased/tightened by presence/absence of an accompanier and the number thereof. In other words, it is preferable that a reference behavior is more eased in a case where there presents an accompanier and as the number thereof is larger.

Regarding “child⋅elderly people⋅handicapped people (user physical strength level)”, a child⋅elderly people⋅handicapped people commonly have a disadvantage for an environmental behavior in terms of physical strength, and thus use of an automobile whose environmental load is high and the like is tolerated. In a case where physical strength of a user is low (including case where physical strength is temporarily reduced due to injuries and sickness and the like), use of an automobile whose environmental load is commonly high and the like is tolerated. Therefore, it is preferable that a reference behavior is eased/tightened by whether or not a user is a child, elderly people, or handicapped people, and/or in accordance with physical strength of the user. In “presence/absence of accompanier”, it is preferable that a reference behavior is eased/tightened by a situation of “child⋅elderly people⋅handicapped people” of an accompanier.

Regarding “weather”, in a case where the weather is bad, use of an automobile whose environmental load is commonly high and the like is tolerated. Particularly, the tendency is stronger as a bad-weather degree is higher. Therefore, it is preferable that a reference behavior is eased/tightened by a state cf the weather and/or extent of a bad-weather degree.

Regarding “target user level”, a difficulty level of an environmental behavior for which a user has motivation or from which a user is able to obtain a challenging wind or a sense of accomplishment is different depending on strength of his/her interest in an environmental behavior and his/her experience level. Therefore, it is preferable that a reference behavior is eased/tightened by a target user level. Moreover, a present user level or a user level aimed by a user may be employed for a target user level.

Note that among the above-mentioned change elements (option parameters), the user U is able to specify presence/absence of luggage, presence/absence of accompanier, target user level, or the like as optional parameters from a screen of an application.

For example, in a case where the user U taps a button of “option” in the screen example illustrated in FIG. 11, as illustrated in FIG. 13, the application is changed into a screen for specifying an option parameter. In the above-mentioned screen, for example, the user U is able to specify each of the above-mentioned presence/absence of luggage, presence/absence of accompanier, target user level and the like by using a touch operation on a corresponding input field.

In the example illustrated in FIG. 13, in a case where there presents an accompanier, each of the number of accompaniers, the number of children, the number of elderly people, and the like may be specified by a touch operation on a corresponding input field. Regarding a target user level, the user U is able to specify a target user level with respect to a user present level by a touch operation on a corresponding input field.

The above-mentioned information on the weather and the like may be specified by a user input as described above; however, may be automatically acquired on the basis of information from various sensors mounted on the user terminal 10, another application, or the like without the specifying by the user U.

The reception unit 103a adjusts the reference behavior information 102b in accordance with a value of each change element which is specified by the user U or is automatically acquired. In the embodiment, relation between magnitudes of values of change elements and the above-mentioned reference behavior condition is one that is illustrated in FIG. 14 (which is stored), and the reference behavior condition is eased/tightened in accordance with the magnitudes of values of change elements on the basis of the above-mentioned relation. The reception unit 103a adjusts the reference behavior information 102b by using a weighted polynomial for multiplying a value of each change element by a corresponding weight coefficient that is preliminarily set in a corresponding change element so as to compute a score value of the reference behavior condition, for example. Note that a conversion table according to a value of each change element may be simply used, or an artificial intelligence (AI) inference model obtained by learning past behaviors of the user U may be used.

In accordance with a present environmental contribution user level of the user U, the reference behavior information 102b may foe adjusted while adding thereto game characteristics. For example, as illustrated in FIG. 15, in a case where a present user level of the user U is “bronze”, the user U may be prompted to select a course regarding a level UP to the next level of “silver”.

In an “average pace course” illustrated in FIG. 15, the reception unit 103a adjusts the reference behavior information 102b by using a content constituted of reference behavior condition that is an average of past statistics, for example. In a “training course”, the reference behavior information 102b is adjusted by using, for example, a content (see FIG. 9) in which an increase/decrease amount of a level point is increased, in other words, a content that strengthen stimulation for evaluation of an environmental contribution activity performed by the user U. Furthermore, for example, a method for changing reference behavior condition “target user level” illustrated in FIG. 14 into a tightening side may be employed.

The reference behavior information 102b is adjusted in accordance with the above-mentioned various change elements, and thus an environmental contribution activity of the user U is able to be evaluated further in accordance with an actual condition such as a behavior and/or a sense of purpose of the user U.

Returning to explanation of FIG. 5. The acquisition unit 103b of the control unit 103 acquires information related to a behavior of the user U whose application use request is received by the reception unit 103a, such as a Global Positioning System (GPS) position, until the GPS position reaches a destination. Note that the acquisition unit 103b may acquire a use situation of public transportation and the like in addition to the GPS position. The acquisition unit 103b stores the acquired information in the behavior information DB 102a.

Note that in FIG. 5, the reception unit 103a and the acquisition unit 103b are illustrated as separated configuration elements; the reception unit 103a and the acquisition unit 103b may be integrated with each other.

The analysis unit 103c analyzes a behavior of the user U on the basis of the behavior information DB 102a. In other words, as described above, the analyzes unit 103c analyzes an actual condition of a behavior of the user U, such as a movement method that is actually taken by the user U up to a destination, on the basis of, for example, a movement route and/or a moving speed of a GPS position and the like.

The determination unit 103d compares an actual condition of a behavior of the user U, which is analyzed by the analysis unit 103c, and the reference behavior information 102b, and further extracts a corresponding environmental contribution level so as to determine an environmental contribution level with respect to the behavior of the user U. Additionally, the determination unit 103d informs the management unit 103e of a determination result.

The management unit 103e manages the user information DB 102c on the basis of the determination result of the determination unit 103d. As described above, the user information DB 102c includes accumulated points and an environmental contribution user level of each of the users U.

The provision unit 103f provides a point service with respect to the user U on the basis of the user information DB 102c. For example, the provision unit 103f informs of the provided point amount whenever the user U reaches a destination. Furthermore, there are additionally informed of previous accumulated points and the like. For example, in a case where a point exchange service is available by accumulated points, the provision unit 103f informs the user U of the fact and a content of the point exchange service.

The big data processing unit 103g executes a statistical process and the like on big data accumulated in the behavior information DB 102a so as to grasp features of the reference behavior information 102b according to a state of the user U and attributes of various features.

The big data processing unit 103g appropriately adjusts the reference behavior information 102b in accordance with the grasped features. In other words, the reference behavior information 102b may be set for each attribute in a state of the user U and various features to be appropriately adjusted. In this case, the corresponding reference behavior information 102b is selected on the basis of a state of the user U and an attribute of various features, and an environmental contribution level of a behavior of the user U is to be evaluated by the selected reference behavior information 102b.

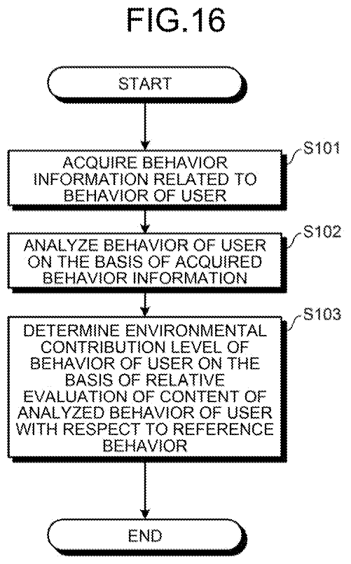

Next, a processing procedure to be executed by the server device 100 according to the embodiment will be explained with reference to FIG. 16. FIG. 16 is a flowchart illustrating a processing procedure to be executed by the server device 100 according to the embodiment.

As illustrated in FIG. 16, the acquisition unit 103b acquires behavior information related to a behavior of the user U (Step S101).

The analysis unit 103c analyzes a behavior of the user U on the basis of the behavior information acquired by the acquisition unit 103b (Step S102).

The determination unit 103d determines an environmental contribution level of the behavior of the user U on the basis of relative evaluation of a behavior content of the user U which is analyzed by the analysis unit 103c with respect to a reference behavior (Step S103). For example, a corresponding reference behavior is selected on the basis of a behavior taken by the user U based on the analysis result and a state of the user U and an attribute in various features, by comparison (comparative relation) between the selected reference behavior and the behavior taken by the user U, an environmental contribution level of the behavior of the user U is determined.

Although illustration thereof is omitted, the determined environmental contribution level is point-converted, and is provided to the user U as a level point. Next, the processing is ended.

As described above, the server device 100 according to the embodiment (corresponding to one example of “information processing apparatus”) is an information processing apparatus that includes the control unit 103 so as to determine an environmental contribution level of a behavior taken by the user U. The control unit 103 acquires behavior information related to a behavior of the user U, analyzes the behavior of the user U on the basis of the acquired behavior information, and determines an environmental contribution level of the behavior of the user U on the basis of relative evaluation of the analyzed behavior of the user U with respect to a reference behavior.

Therefore, in accordance with the server device 100 according to the embodiment, an environmental contribution activity of the user U is able to be evaluated in accordance with an actual condition.

In a case where a behavior amount of the analyzed behavior of the user U falls below a reference behavior amount that is a reference of an environmental contribution activity, the control unit 103 determines that the behavior of the user U is not the environmental contribution activity.

Therefore, in accordance with the server device 100 according to the embodiment, evaluation of a behavior of the user U which falls below a reference behavior amount is possible, in other words, it is possible to evaluate that a behavior taken by the user U is not an environmental contribution behavior.

Table data in which behavior contents and environmental contribution levels are associated with each other is provided, and the control unit 103 determines an environmental contribution level on the basis of the above-mentioned table data.

Therefore, in accordance with the server device 100 according to the embodiment, it is possible to determine an environmental contribution level of the user U on the basis of table data in which behavior contents and environmental contribution levels are associated with each other.

A reference behavior is set by a distribution of data of environmental contribution levels indicating not to be an environmental contribution activity stored in the above-mentioned table data.

Therefore, in accordance with the server device 100 according to the embodiment, on the basis of a reference behavior that is set by a distribution of the above-mentioned data, a behavior of the user U that is not in accordance with an actual condition of an environmental contribution activity is able to be appropriately evaluated not to correspond to an environmental contribution activity.

The control unit 103 changes the table data according to the behavior amount of the behavior of the user U on the basis of the behavior information.

Therefore, in accordance with the server device 100 according to the embodiment, it is possible to appropriately determine an environmental contribution level while dynamically changing reference behavior condition of the above-mentioned table data in accordance with situations and the like.

The above-mentioned behavior information includes presence/absence of luggage, a state of the user U including presence/absence of an accompanier, a peripheral situation of the user U including the weather, or a user level with respect to environmental contribution of a user based on past behavior history of the user.

Therefore, in accordance with the server device 100 according to the embodiment, it is possible to determine an environmental contribution level in accordance with presence/absence of luggage, a state of the user U including presence/absence of accompanier, a peripheral situation of the user U including the weather, a user level with respect to environmental contribution of a user based on a past behavior history of the user, and the like.

Determination threshold data storing therein a threshold of an environmental contribution activity determination with respect to a behavior content is provided, and the control unit 103 determines an environmental contribution level on the basis of the above-mentioned determination threshold data.

Therefore, in accordance with the server device 100 according to the embodiment, it is possible to determine an environmental contribution level on the basis of the above-mentioned determination threshold data.

The control unit 103 compares a behavior content indicating a combination of a movement distance or a movement time interval in the behavior performed by the user U and a movement method with the above-mentioned reference behavior amount prescribed by a combination of the movement distance or the movement time interval and the movement method, and determines an environmental contribution level of the behavior of the user.

Therefore, in accordance with the server device 100 according to the embodiment, it is possible to appropriately determine whether or not a movement behavior whose movement distance to be an environmental contribution activity is different depending on a movement method is an environmental contribution activity.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a control circuitry configured to determine an environmental contribution level of a behavior performed by a user, wherein
the control circuitry is further configured to:
acquire behavior information related to a behavior of a user;
analyze the behavior of the user based on the acquired behavior information; and
determine an environmental contribution level of the behavior of the user based on relative evaluation of the analyzed behavior of the user with respect to a reference behavior.

2. The information processing apparatus according to claim 1, wherein
the control circuitry is further configured to:
in a case where a behavior amount of the analyzed behavior of the user falls below a reference behavior amount that is a reference of an environmental contribution activity, determine that the behavior of the user is not the environmental contribution activity.

3. The information processing apparatus according to claim 2 further comprising:
table data in which behavior contents and environmental contribution levels are associated with each other, wherein
the control circuitry is further configured to:
determine an environmental contribution level based on the table data.

4. The information processing apparatus according to claim 3, wherein
a reference behavior is set by a distribution of data of environmental contribution levels indicating not to be the environmental contribution activity stored in the table data.

5. The information processing apparatus according to claim 3, wherein
the control circuitry is further configured to:
change the table data according to the behavior amount of the behavior of the user, based on the behavior information.

6. The information processing apparatus according to claim 1, wherein
the behavior information includes:
presence/absence of luggage, a state of the user including presence/absence of an accompanier, a peripheral situation of the user including weather, or a user level with respect to environmental contribution of a user based on past behavior history of the user.

7. The information processing apparatus according to claim 2, wherein
the behavior information includes:
presence/absence of luggage, a state of the user including presence/absence of an accompanier, a peripheral situation of the user including weather, or a user level with respect to environmental contribution of a user based on past behavior history of the user.

8. The information processing apparatus according to claim 1 further comprising:
determination threshold data storing therein a threshold of an environmental contribution activity determination with respect to a behavior content, wherein
the control circuitry is further configured to:
determine an environmental contribution level based on the determination threshold data.

9. The information processing apparatus according to claim 3 further comprising:
determination threshold data storing therein a threshold of an environmental contribution activity determination with respect to a behavior content, wherein
the control circuitry is further configured to:
determine an environmental contribution level based on the determination threshold data.

10. The information processing apparatus according to claim 1, wherein
the control circuitry is further configured to:
compare a behavior content indicating a combination of a movement distance or a movement time interval in the behavior performed by the user and a movement method with a reference behavior amount prescribed by a combination of the movement distance or the movement time interval and the movement method; and
determine an environmental contribution level of the behavior of the user.

11. The information processing apparatus according to claim 2, wherein
the control circuitry is further configured to:
compare a behavior content indicating a combination of a movement distance or a movement time interval in the behavior performed by the user and a movement method with a reference behavior amount prescribed by a combination of the movement distance or the movement time interval and the movement method; and
determine an environmental contribution level of the behavior of the user.

12. The information processing apparatus according to claim 3, wherein
the control circuitry is further configured to:
compare a behavior content indicating a combination of a movement distance or a movement time interval in the behavior performed by the user and a movement method with a reference behavior amount prescribed by a combination of the movement distance or the movement time interval and the movement method; and
determine an environmental contribution level of the behavior of the user.

13. The information processing apparatus according to claim 4, wherein
the control circuitry is further configured to:
compare a behavior content indicating a combination of a movement distance or a movement time interval in the behavior per formed by the user and a movement method with a reference behavior amount prescribed by a combination of the movement distance or the movement time interval and the movement method; and
determine an environmental contribution level of the behavior of the user.

14. The information processing apparatus according to claim 5, wherein
the control circuitry is further configured to:
compare a behavior content indicating a combination of a movement distance or a movement time interval in the behavior performed by the user and a movement method with a reference behavior amount prescribed by a combination of the movement distance or the movement time interval and the movement method; and
determine an environmental contribution level of the behavior of the user.

15. The information processing apparatus according to claim 6, wherein
the control circuitry is further configured to:
compare a behavior content indicating a combination of a movement distance or a movement time interval in the behavior performed by the user and a movement method with a reference behavior amount prescribed by a combination of the movement distance or the movement time interval and the movement method; and
determine an environmental contribution level of the behavior of the user.

16. The information processing apparatus according to claim 7, wherein
the control circuitry is further configured to:
compare a behavior content indicating a combination of a movement distance or a movement time interval in the behavior performed by the user and a movement method with a reference behavior amount prescribed by a combination of the movement distance or the movement time interval and the movement method; and
determine an environmental contribution level of the behavior of the user.

17. The information processing apparatus according to claim 8, wherein
the control circuitry is further configured to:
compare a behavior content indicating a combination of a movement distance or a movement time interval in the behavior performed by the user and a movement method with a reference behavior amount prescribed by a combination of the movement distance or the movement time interval and the movement method; and
determine an environmental contribution level of the behavior of the user.

18. The information processing apparatus according to claim 9, wherein
the control circuitry is further configured to:
compare a behavior content indicating a combination of a movement distance or a movement time interval in the behavior performed by the user and a movement method with a reference behavior amount prescribed by a combination of the movement distance or the movement time interval and the movement method; and
determine an environmental contribution level of the behavior of the user.

19. An information processing system comprising:
an information processing apparatus and a terminal device that are configured to perform, information communication therebetween, wherein
the information processing apparatus is configured to:
acquire behavior information related to a behavior of a user from the terminal device;
analyze the behavior of the user based on the acquired behavior information;
determine an environmental contribution level of the behavior of the user based on relative evaluation of the analyzed behavior of the user with respect to a reference behavior; and
transmit environmental contribution level information related to the determined environmental contribution level to the terminal device, and
the terminal device is configured to:
collect the behavior information;
transmit the collected behavior information to the information processing apparatus;
acquire the environmental contribution level information from the information processing apparatus; and
provides the acquired environmental contribution level information to the user.

20. An information processing method for determining an environmental contribution level of a behavior of a user, the method comprising:
acquiring behavior information related to a behavior of a user;
analyzing the behavior of the user based on the acquired behavior information; and
determining an environmental contribution level of the behavior of the user based on relative evaluation of the analyzed behavior of the user with respect to a reference behavior.
